(19) United States
(12) Patent Application Publication
(10) Pub. No.: US 2016/0089696 A1
(43) Pub. Date: Mar. 31, 2016

(54) SUBSTRATE PROCESSING METHOD

(71) Applicant: SCREEN Holdings Co., Ltd., Kyoto (JP)

(72) Inventor: Masahiro KIMURA, Kyoto-shi (JP)

(21) Appl. No.: 14/849,845

(22) Filed: Sep. 10, 2015

(30) Foreign Application Priority Data
Sep. 30, 2014 (JP) 2014-200696

(51) Int. Cl. B05D 5/08; B05D 3/10

(52) U.S. Cl. CPC B05D 5/08; B05D 3/104; B05D 3/107

(57) ABSTRACT

A substrate processing method includes the steps of cleaning a substrate in a processing tank, forming an organic solvent vapor atmosphere in a chamber, elevating the substrate to replace a rinse on a surface of the substrate with an organic solvent, draining the rinse from the processing tank, moving the substrate into the processing tank, making the surface of the substrate water-repellent, elevating the substrate and supplying an organic solvent vapor to the substrate to remove water repellent from the surface of the substrate, and drying the substrate with inert gas. The water repellent is removed above the processing tank, and thus the substrate can be dried while contamination of the substrate with particles that can be generated in the processing tank in this step is suppressed.

### BACKGROUND OF THE INVENTION

1. Field of the Invention

The present invention relates to a substrate processing method for processing a semiconductor wafer and a glass substrate for liquid crystal display (hereinafter, simply referred to as substrates) with processing liquid.

2. Description of the Background Art

A substrate processing apparatus including a processing tank, a substrate elevating mechanism, and a substrate drying mechanism is known. The processing tank is used to dip a substrate into chemical liquid, a rinse, and the like. The substrate elevating mechanism moves the substrate between the processing tank and space above the processing tank. The substrate drying mechanism blows inert gas and the like onto the substrate in the space above the processing tank to dry the rinse, such as pure water. When the rinse is dried in such a substrate processing apparatus, a pattern formed on the substrate might collapse due to capillary action of the rinse remaining in the pattern.

To solve the problem, a technique of forming a water repellent protective film on the surface of the substrate in advance to reduce surface tension of liquid acting on the pattern during drying is known (e.g., US2009/0311874). In this technique, water repellent is supplied to the substrate in the processing tank to make the substrate water-repellent. An alcohol rinse is then performed by supplying IPA to the substrate in the processing tank to replace unreacted water repellent remaining on the surface of the substrate with the IPA and remove the unreacted water repellent.

The substrate processing method according to US2009/0311874 can suppress the pattern collapse caused by drying. When the alcohol rinse is performed after water repellent processing, however, unreacted water repellent remaining in the storage tank might react with the IPA to generate particles, such as silica particles. As a result, the substrate in the processing tank might be contaminated with the particles.

### SUMMARY OF THE INVENTION

The present invention is directed to a substrate processing method.

In one aspect of the present invention, the substrate processing method includes: the steps of: dipping a substrate into a rinse stored in a processing tank to clean a surface of the substrate with the rinse; supplying an organic solvent vapor into a chamber surrounding the processing tank to form an organic solvent vapor atmosphere inside the chamber including space above the processing tank; elevating the substrate to the space above the processing tank to replace the rinse adhering to the surface of the substrate with an organic solvent; draining the rinse in the processing tank; moving the substrate into the processing tank; supplying water repellent to the surface of the substrate having been moved into the processing tank to make the surface of the substrate water-repellent; elevating the substrate above the processing tank, and supplying an organic solvent vapor to the substrate above the processing tank to remove unreacted water repellent remaining on the surface of the substrate; and supplying inert gas to the substrate to dry the substrate.

The water repellent processing is performed in the processing tank to make the surface of the substrate water-repellent. This prevents the pattern formed on the surface of the substrate from collapsing during drying performed by supplying the inert gas to the surface of the substrate. After the water repellent processing, the unreacted water repellent remaining on the surface of the substrate is removed above the processing tank. If the unreacted water repellent remaining in the processing tank reacts with the organic solvent used to remove the unreacted water repellent to generate particles after the water repellent processing, the substrate is located above the processing tank at the time. Contamination of the substrate is prevented or suppressed by removing the unreacted water repellent. As a result, the substrate can be dried while cleanliness of the substrate is maintained.

The organic solvent is preferably IPA.

The organic solvent vapor supplied to the substrate in removing the unreacted water repellent is preferably at a higher temperature than the water repellent supplied to the substrate in making the surface of the substrate water-repellent.

It is an object of the present invention to provide a substrate processing method that enables drying of the substrate without causing the pattern collapse while maintaining cleanliness of the substrate.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic diagram illustrating the structure of a substrate processing apparatus according to one embodiment of the present invention;

FIG. 2 is a flow chart describing operations of substrate processing performed by the substrate processing apparatus 1;

FIG. 3 is a schematic diagram illustrating operation of the substrate processing apparatus in step S1 of FIG. 2;

FIG. 4 is a schematic diagram illustrating operation of the substrate processing apparatus in step S2 of FIG. 2;

FIG. 5 is a schematic diagram illustrating operation of the substrate processing apparatus in step S3 of FIG. 2;

FIG. 6 is a schematic diagram illustrating operation of the substrate processing apparatus in step S4 of FIG. 2;

FIG. 7 is a schematic diagram illustrating operation of the substrate processing apparatus in step S5 of FIG. 2;

FIG. 8 is a schematic diagram illustrating operation of the substrate processing apparatus in step S6 of FIG. 2;

FIG. 9 is a schematic diagram illustrating operation of the substrate processing apparatus in step S7 of FIG. 2;

FIG. 10 is a schematic diagram illustrating operation of the substrate processing apparatus in step S8 of FIG. 2;

FIG. 11 is a schematic diagram illustrating operation of the substrate processing apparatus in step S9 of FIG. 2;

FIG. 12 is a schematic diagram illustrating operation of the substrate processing apparatus in step S10 of FIG. 2; and

FIG. 13 is a schematic diagram illustrating operation of the substrate processing apparatus in step S11 of FIG. 2.

### DESCRIPTION OF THE PREFERRED EMBODIMENTS

The following describes a substrate processing apparatus according to one embodiment of the present invention with reference the drawings. In the following description, a substrate refers to a semiconductor wafer, a glass substrate for liquid crystal display, a glass substrate for plasma display panel (PDP), a glass substrate for photomask, a substrate for optical disc, and the like.

### Structure of Main Components of Substrate Processing Apparatus

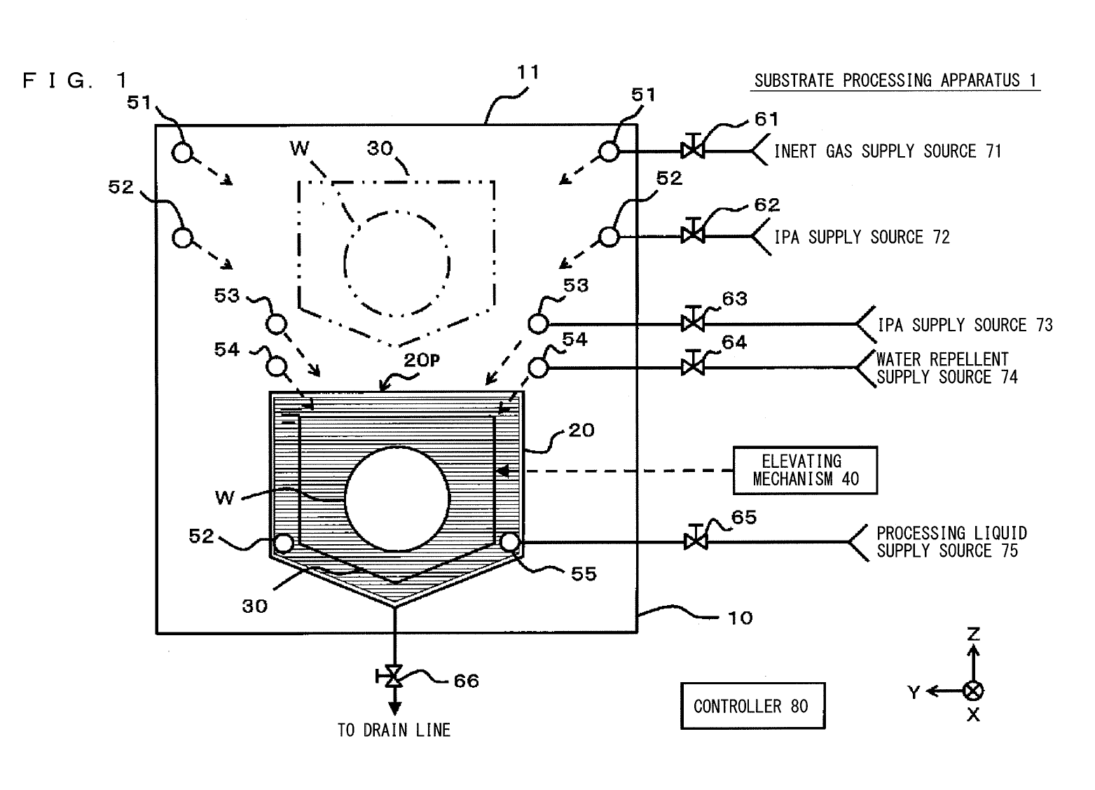

FIG. 1 is a front view of a substrate processing apparatus 1 according to an embodiment of the present invention.

The substrate processing apparatus 1 blows IPA, which is an organic solvent, onto a substrate having been rinsed with pure water to dry the substrate. The substrate processing apparatus 1 mainly includes: a chamber 10; a processing tank 20; a holding mechanism 30; an elevating mechanism 40; nozzles 51 to 55; valves 61 to 65 for opening and closing the nozzles; an inert gas supply source 71 for supplying inert gas, such as nitrogen gas, to the nozzles 51; an IPA supply source 72 for supplying IPA vapors to the nozzles 52; an IPA supply source 73 for supplying IPA vapors to the nozzles 53; a water repellent supply source 74 for supplying water repellent to the nozzles 54; a processing liquid supply source 75 for supplying a rinse, such as pure water, to the processing liquid supply nozzle 55; and a controller 80.

The chamber 10 is an enclosure for housing therein the processing tank 20, the elevating mechanism 40, the nozzles 51 to 55, and the like. An upper part 11 of the chamber 10 can be opened and closed. When the upper part 11 of the chamber 10 is opened, substrates W can be transported through the opening part. When the upper part 11 of the chamber 10 is closed, space inside the chamber 10 is closed space.

The processing tank 20 is used to store chemical liquid, such as fluorinated acid, or a rinse, such as pure water, (hereinafter, collectively referred to as “processing liquid”) to sequentially process the surfaces of the substrates, and is housed in the chamber 10. The nozzle 55 is disposed near the bottom of the processing tank 20, and processing liquid can be supplied from the processing liquid supply source 75 to the processing tank 20 through the nozzle 55. The processing liquid is supplied from the bottom of the processing tank 20, and flows out of the processing tank 20 from an opening 20P. The processing tank 20 can drain the processing liquid stored in the processing tank 20 to a drain line by opening a drain valve 66.

The holding mechanism 30 holds a plurality of substrates W separated from one another in an X direction with their main surfaces (circuit formation surfaces) being vertical. The elevating mechanism 40 can elevate and lower the holding mechanism 30 in a vertical direction (Z direction) to move the substrates W held by the holding mechanism 30 between a position (a position shown in solid lines in FIG. 1, and referred to as a lower position) where the substrates W are dipped in the processing liquid stored in the processing tank 20 and a position (a position shown in imaginary lines in FIG. 1, and referred to as an upper position) where the substrates W have been elevated from the processing liquid.

The nozzles 53 and 54 are disposed near the opening 20P in the space above the processing tank 20.

The nozzles 53 are hollow tubular members extending in the X direction, and each have a plurality of discharge holes (not illustrated) arranged at equal intervals in the X direction. The nozzles 53 are two nozzles arranged in a Y direction along upper corners of the processing tank 20 so as to be in parallel to each other. IPA vapors are discharged from the above-mentioned discharge holes of the nozzles 53 to the opening 20P of the processing tank 20 to form an atmosphere containing the IPA vapors inside the processing tank 20.

The IPA vapors are supplied from the IPA supply source 73 external to the chamber 10 to the nozzles 53. The valve 63 is disposed along a duct between the nozzles 53 and the IPA supply source 73, and the quantity of the IPA vapors discharged from the nozzles 53 can be controlled by adjusting opening of the valve 63.

The nozzles 54 are hollow tubular members extending in the X direction, and each have a plurality of discharge holes (not illustrated) arranged at equal intervals in the X direction. The nozzles 54 are two nozzles arranged in the Y direction along the upper corners of the processing tank 20 so as to be in parallel to each other. Water repellent is discharged from the above-mentioned discharge holes of the nozzles 54 to the opening 20P of the processing tank 20 to store liquid-phase water repellent in the processing tank 20 and to form an atmosphere containing a mist of the water repellent inside the processing tank 20.

The water repellent is silicon-based water repellent that makes silicon itself and a compound containing silicon hydrophobic, or metal-based water repellent that makes metal itself and a compound containing metal hydrophobic.

The metal-based water repellent contains at least one of amine having a hydrophobic group and an organic silicon compound, for example.

The silicon-based water repellent is a silane coupling agent, for example. The silane coupling agent contains at least one of hexamethyldisilazane (HMDS), tetramethylsilane (TMS), fluorinated alkylchlorosilane, alkyldisilazane, and non-chloro water repellent, for example.

The non-chloro water repellent contains at least one of dimethylsilyldimethylamine, dimethylsilyldiethylamine, hexamethyldisilazane, tetramethyldisilazane, bis(dimethylamino)dimethylsilane, N,N-dimethylaminotrimethylsilane, N-(trimethylsilyl) dimethylamine, and an organosilane compound, for example.

It is desirable to use water repellent diluted with a solvent that is mutually soluble with a hydrophilic organic solvent, such as IPA. In this case, it is desirable to mix the water repellent and the solvent that is mutually soluble with the hydrophilic organic solvent, such as IPA, together immediately before the nozzles 54, and then supply the mixture to the nozzles 54.

In the space above the processing tank 20, the nozzles 51 and 52 are disposed above the above-mentioned nozzles 53 and 54.

Nitrogen gas is supplied from the inert gas supply source 71 external to the chamber 10 to the nozzles 51. It is desirable to heat the nitrogen gas to room temperature or higher. The valve 61 is disposed along a duct between the nozzles 51 and the inert gas supply source 71, and the quantity of the nitrogen gas discharged from the nozzles 51 is controlled by adjusting opening of the valve 61. The nozzles 51 are directed to the substrates W elevated to the upper position. The nitrogen gas is discharged from the nozzles 51 to fill the space inside the chamber 10 including the space above the processing tank 20 with the nitrogen gas, and the substrates W located at the upper position are dried (described in detail later).

The IPA vapors are supplied from the IPA supply source 72 external to the chamber 10 to the nozzles 52. The valve 62 is disposed along a duct between the nozzles 52 and the IPA supply source 72, and the quantity of the IPA vapors discharged from the nozzles 52 is controlled by adjusting opening of the valve 62. The nozzles 52 are directed to the substrates W elevated to the upper position. The IPA vapors are discharged from the nozzles 52 to fill the space inside the chamber 10 including the space above the processing tank 20 with the IPA vapors, and excess water repellent can be removed from the substrates W located at the upper position by the IPA vapors (described in detail later).

The above-mentioned valves 61 to 66, elevating mechanism 75, supply sources 71 to 75 operate through control performed by the controller 80.

### Substrate Processing Performed by Substrate Processing Apparatus 1

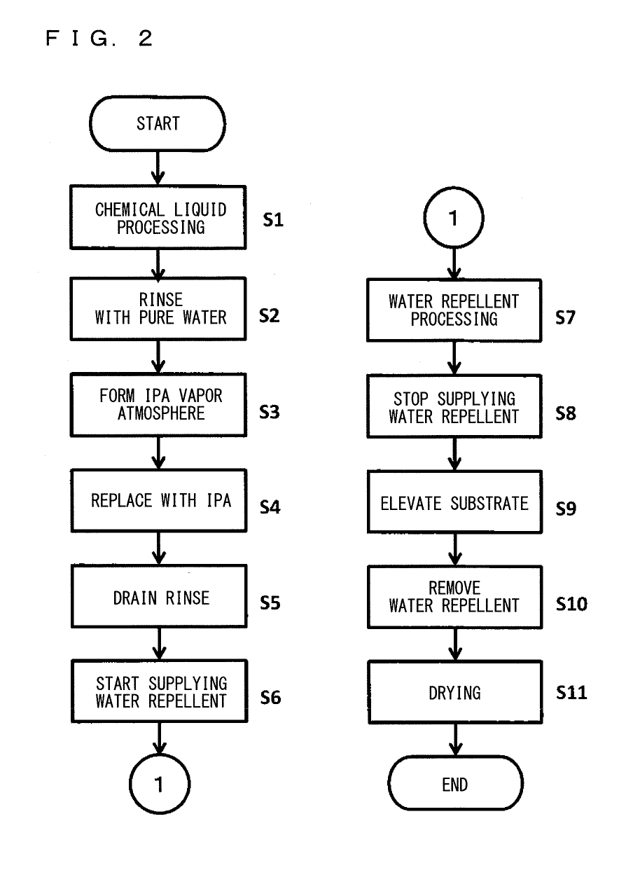

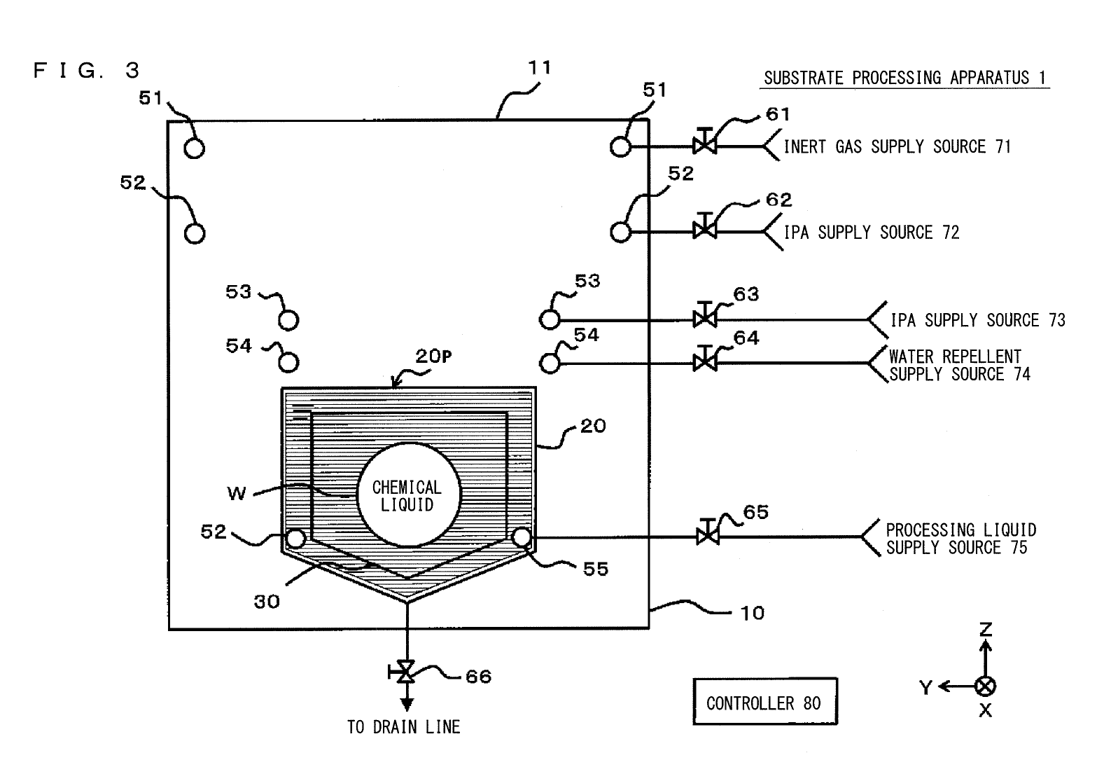

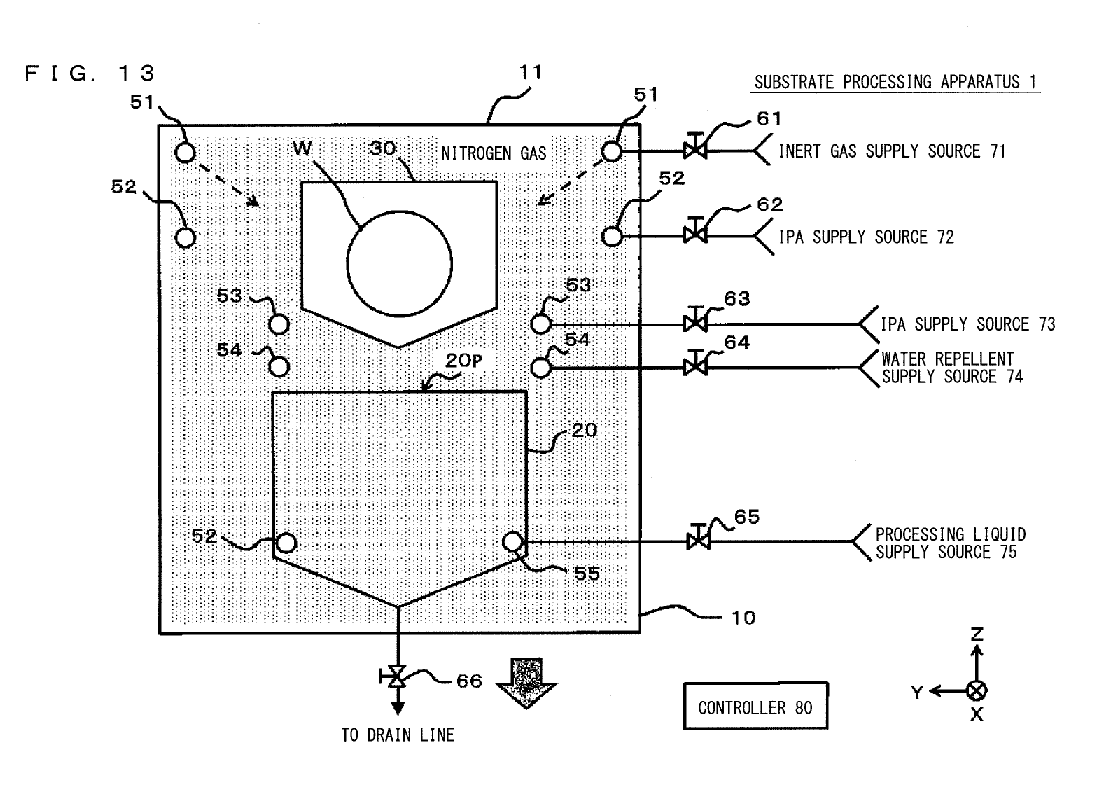

The substrate processing performed using the substrate processing apparatus 1 is described next. FIG. 2 is a flow chart describing operations of the substrate processing performed by the substrate processing apparatus 1. FIGS. 3 to 13 are schematic diagrams describing the substrate processing performed by the substrate processing apparatus 1.

The controller 80 stores chemical liquid, such as fluorinated acid, in the processing tank 20 in a state where the holding mechanism 30 is located at the lower position in the processing tank 20 to perform chemical liquid processing, such as cleaning, with respect to the substrates W held by the holding mechanism 30 (step S1 in FIG. 2, and FIG. 3).

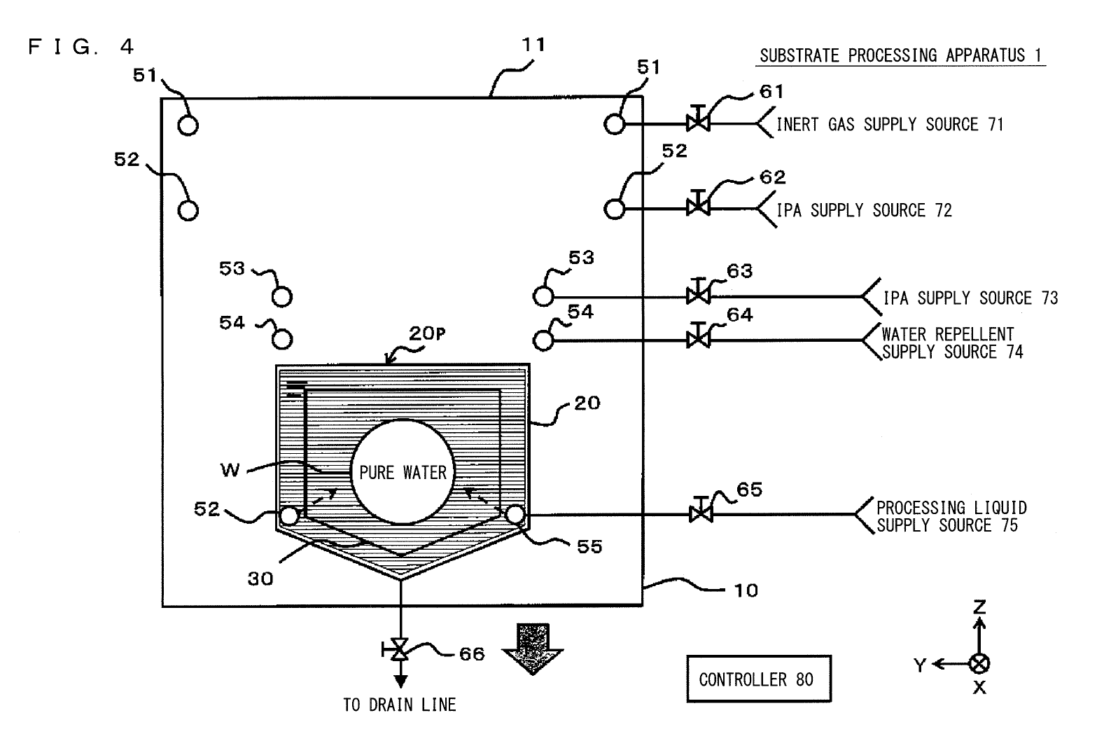

The controller 80 then opens the valve 65 to introduce pure water from the processing liquid supply source 75 to the nozzle 55 while opening the valve 66 to drain the chemical liquid stored in the processing tank 20. As a result, the chemical liquid stored in the processing tank 20 is gradually replaced with the pure water to perform a rinse of cleaning the surfaces of the substrates W with the pure water (step S2 in FIG. 2, and FIG. 4).

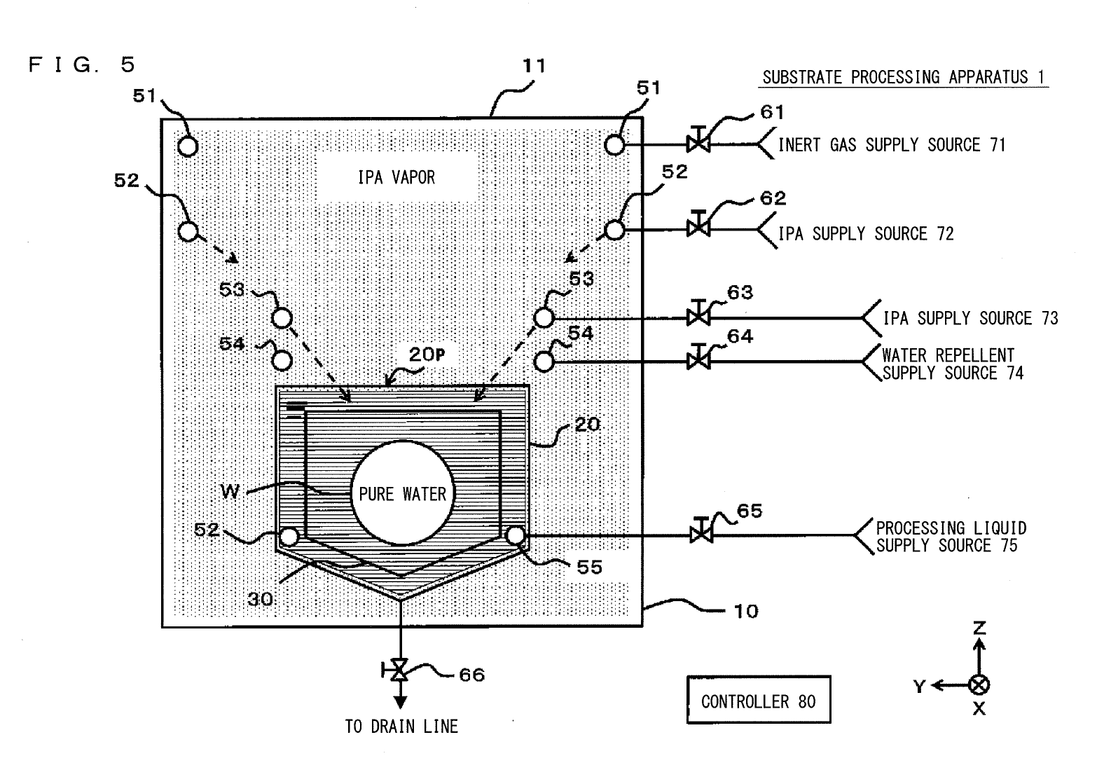

The controller 80 then opens the valve 62 to supply IPA vapors from the nozzles 52 to the space above the processing tank 20. The controller 80 also opens the valve 63 to supply IPA vapors from the nozzles 53 to the opening 20P of the processing tank 20. As a result, an IPA vapor atmosphere is formed inside the chamber 10 surrounding the processing tank 20 (step S3 in FIG. 2, and FIG. 5).

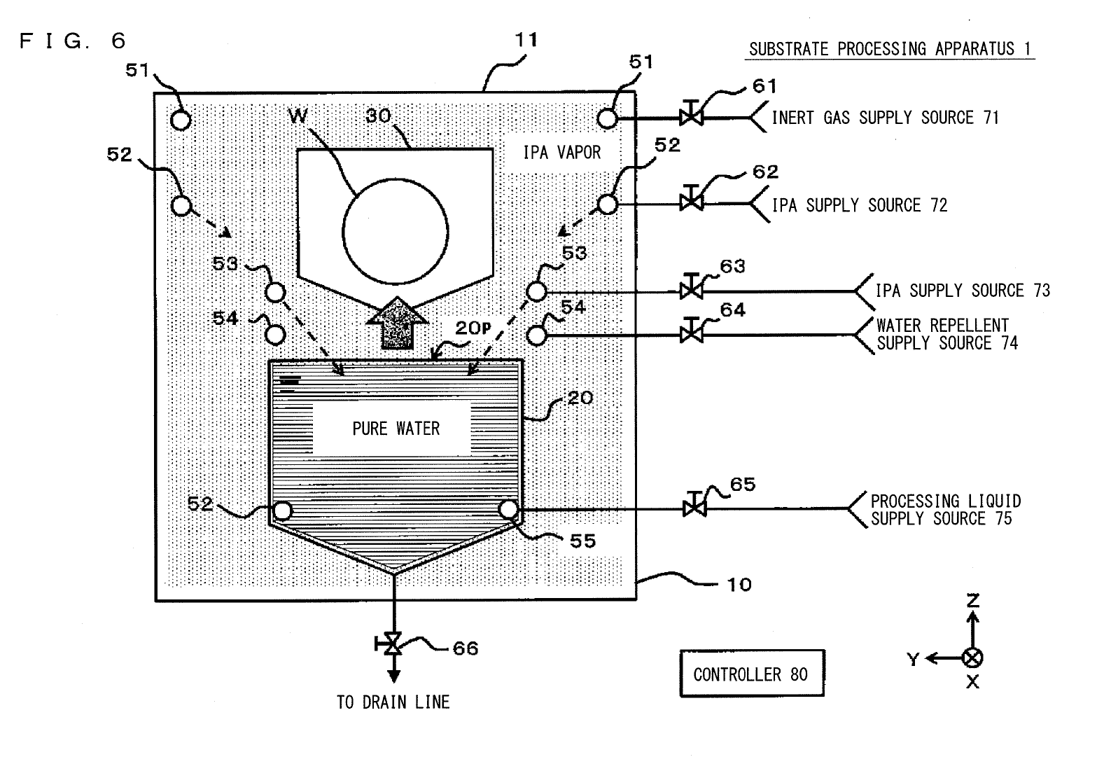

The controller 80 then controls the elevating mechanism 40 to move the holding mechanism 30 located at the lower position to the upper position above the processing tank 20 while continuing supplying the IPA vapors from the nozzles 52 and 53. The substrates W held by the holding mechanism 30 are exposed to the IPA vapors supplied from the nozzles 52 and 53 while the holding mechanism 30 is elevated from the lower position to the upper position. As a result, the pure water adhering to the substrates W is replaced with the IPA (step S4 in FIG. 2, and FIG. 6).

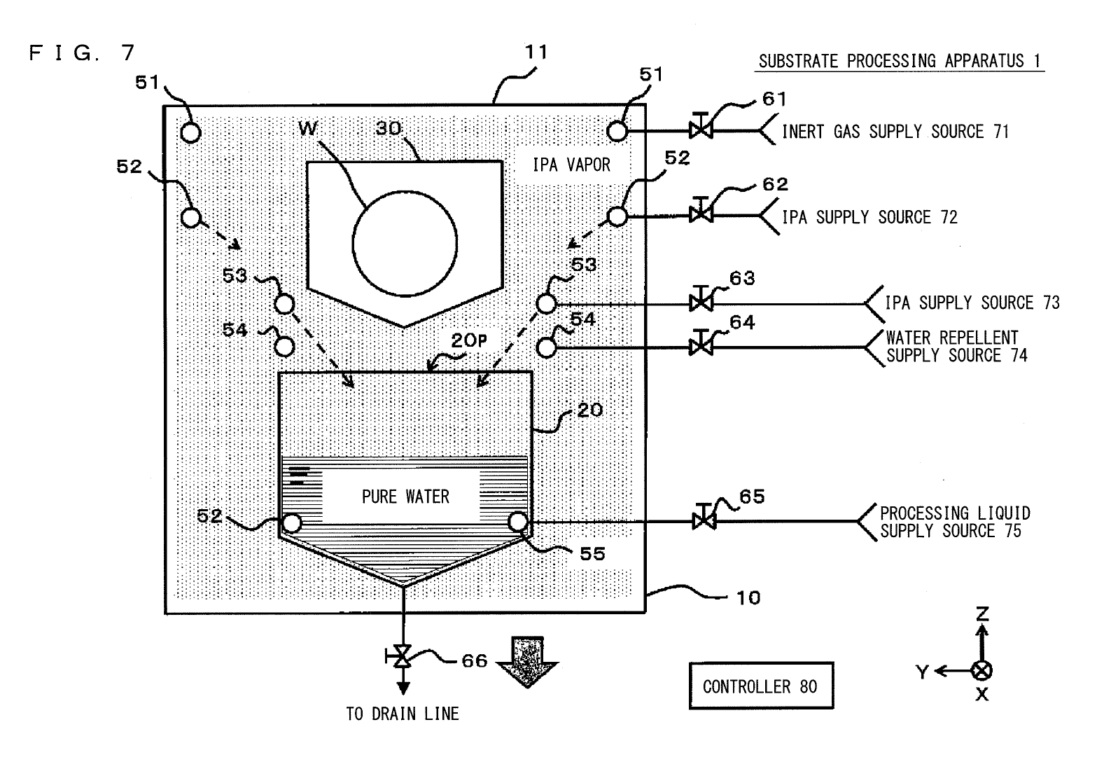

The controller 80 then opens the valve 66 to drain the pure water stored in the processing tank 20 (step S5 in FIG. 2, and FIG. 7).

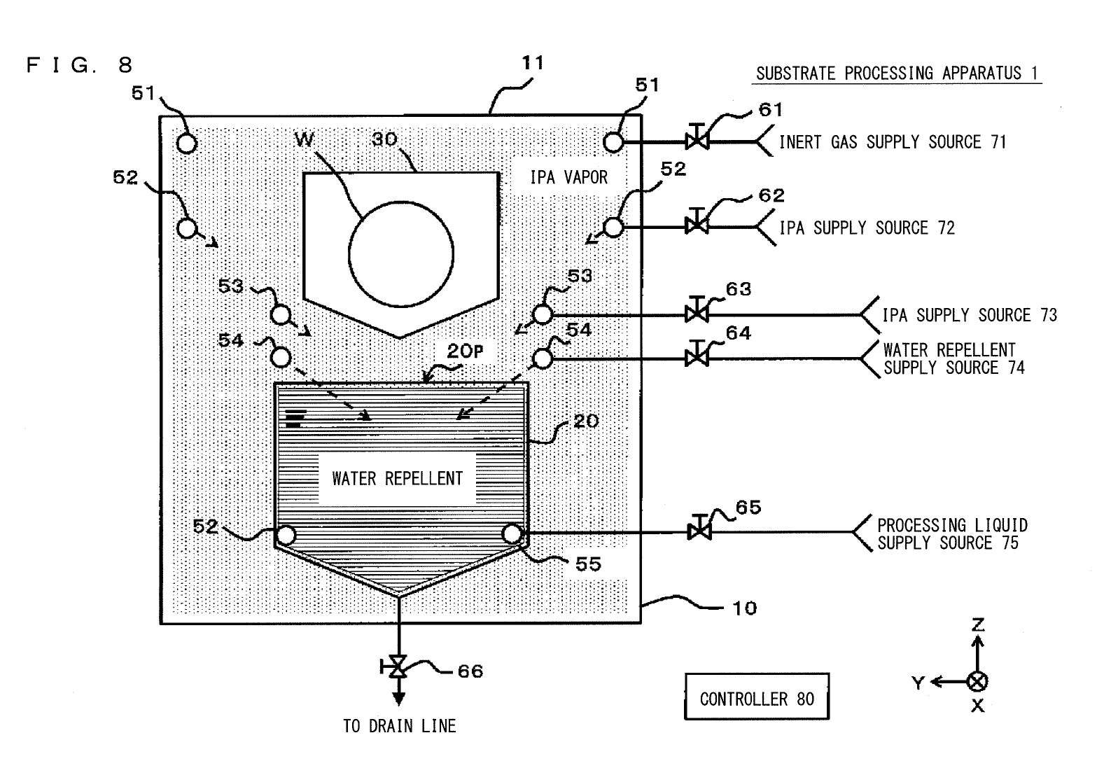

The controller 80 then controls the valves 62 and 63 to adjust (reduce) the quantity of the IPA vapors discharged from the nozzles 52 and 53. The controller 80 also closes the valve 66 so that a fluid can be stored in the processing tank 20. The controller 80 then opens the valve 64 to start supplying water repellent from the nozzles 54 to the processing tank 20. As a result, the water repellent is stored in the processing tank 20 (step S6 in FIG. 2, and FIG. 8). The water repellent is not limited to liquid water repellent, and may be in the form of a vapor or a mist. The water repellent may be supplied to the processing tank 20 from the nozzle 55 in the processing tank 20 in place of (or in addition to) the nozzles 54.

When the substrate to which moisture adheres is brought into direct contact with the water repellent, modifying performance can be reduced, and foreign matter can be generated. In the present embodiment, replacement with IPA (step S4) is performed before the water repellent processing in step S7 to remove moisture from the surfaces of the substrates W. As described above, the water repellent processing (step S7) is performed with respect to the substrates W from which moisture has been removed. Generation of foreign matter during the water repellent processing can thus be prevented or suppressed.

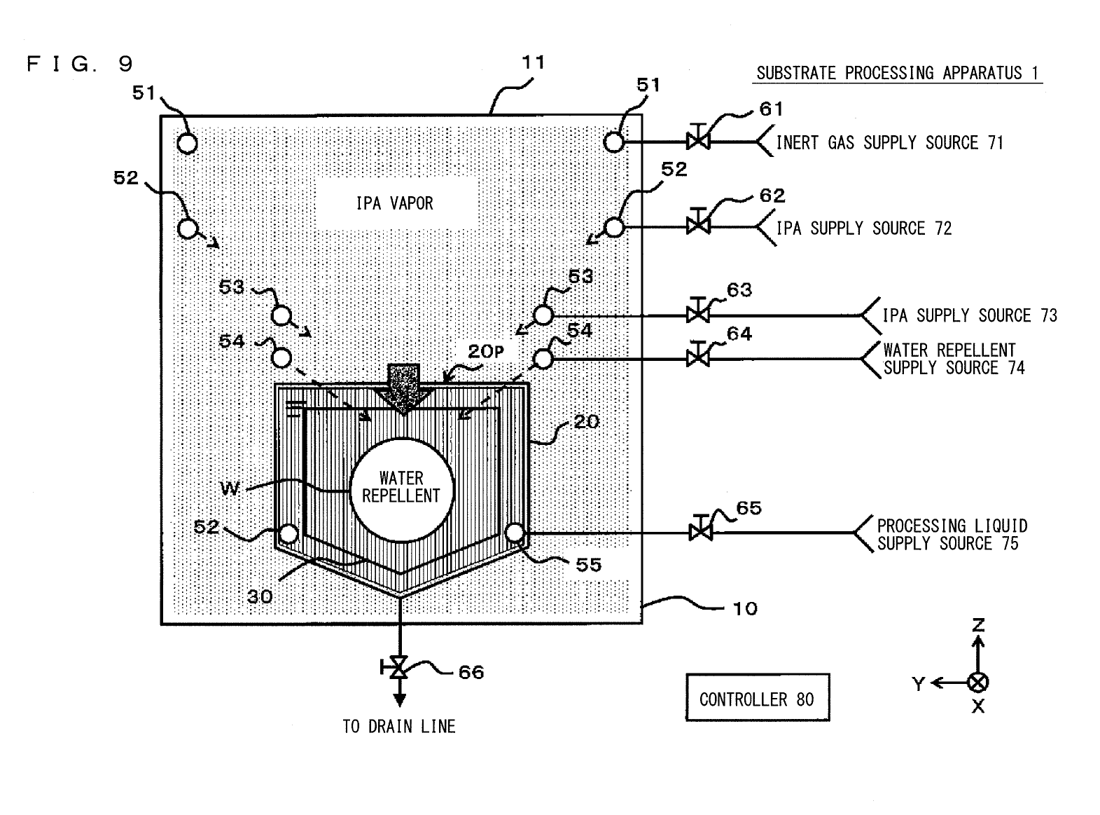

The controller 80 then controls the elevating mechanism 40 to move the holding mechanism 30 located at the upper position to the lower position in the processing tank 20. As a result, the surfaces of the substrates W held by the holding mechanism 30 are modified to be water-repellent by the water repellent (the water repellent processing, step S7 in FIG. 2, and FIG. 9). The controller 80 may control the elevating mechanism 40 to rock the holding mechanism 30 in the processing tank 20 when the water repellent processing is performed in step S7. As a result, the surfaces of the substrates W are more evenly modified.

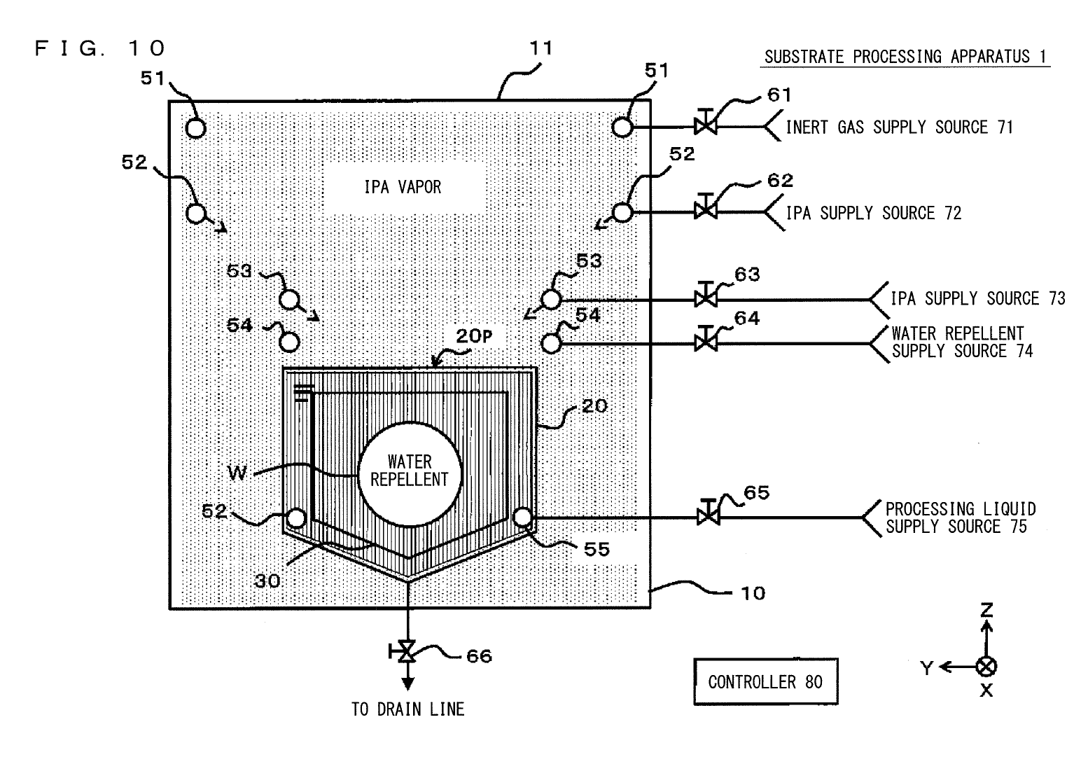

The controller 80 then controls the valve 64 to stop supplying the water repellent from the nozzles 54 (step S8 in FIG. 2, and FIG. 10).

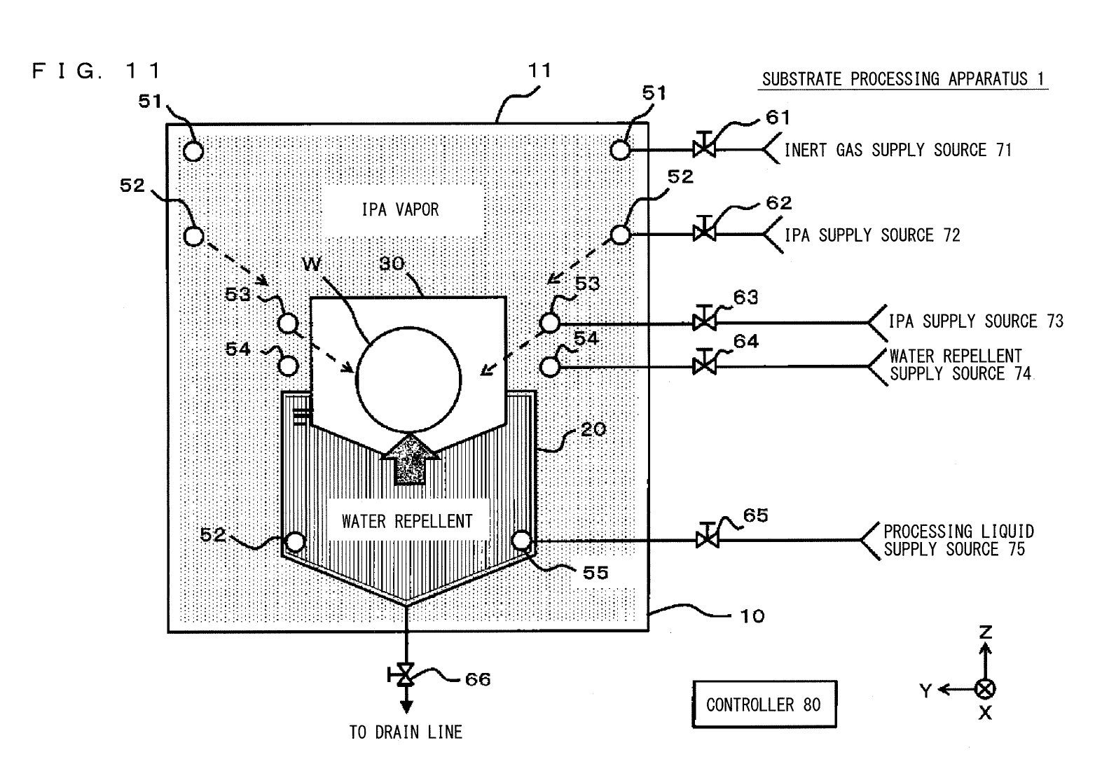

The controller 80 then controls the elevating mechanism 40 to move the holding mechanism 30 located at the lower position to the upper position above the processing tank 20. As a result, the substrates W whose surfaces have been modified to be water repellent are elevated to the upper position above the processing tank 20. Unreacted water repellent adhering to the substrates W is removed by the IPA vapors from the nozzles 52 and 53 (step S9 in FIG. 2, and FIG. 11). The holding mechanism 30 is moved from the lower position to the upper position in a relatively short time (e.g., in approximately 10 seconds), and thus only a few particles, such as silica particles, are generated if the unreacted water repellent adhering to the substrates W reacts with the IPA. The surfaces of the substrates W are therefore kept clean.

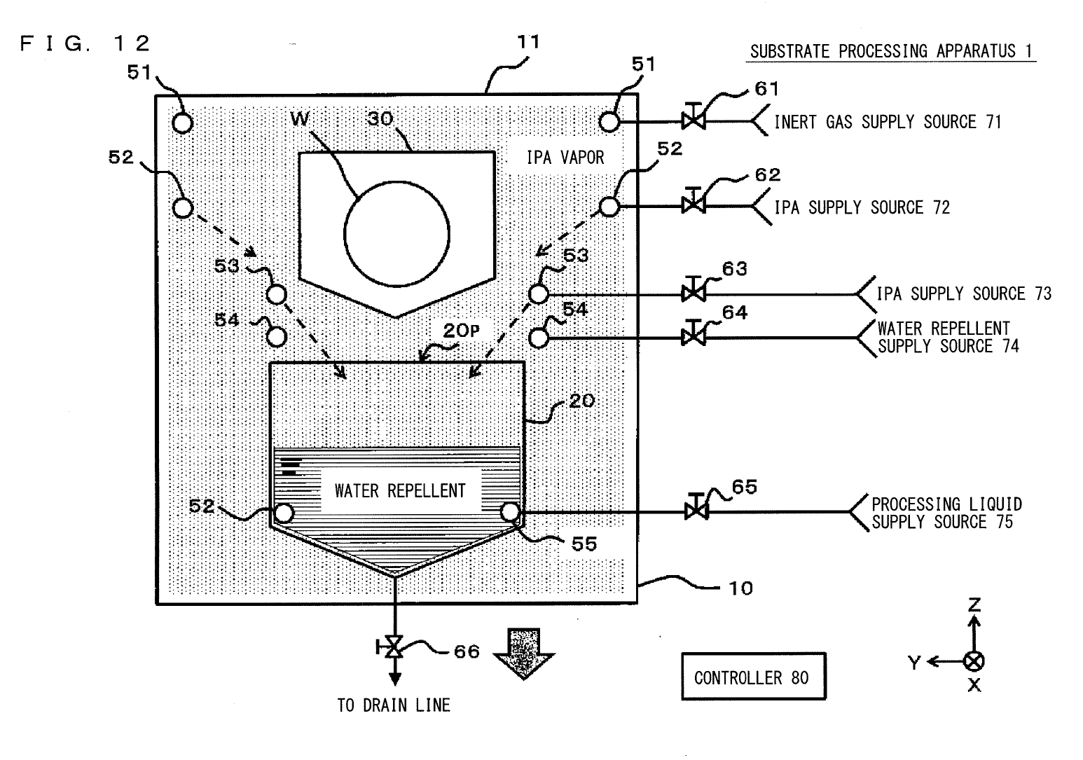

The controller 80 then opens the valve 66 while continuing supplying the IPA vapors from the nozzles 52 and 53. As a result, the water repellent is removed from the surfaces of the substrates W. In addition, the unreacted water repellent adhering to an inner wall and the like of the processing tank 20 is removed by the IPA vapors from the nozzles 53, and is drained from the drain line to the outside of the processing tank 20 (step S10 in FIG. 2, and FIG. 12). The unreacted water repellent adhering to the inner wall and the like of the processing tank 20 can react with the IPA vapors to generate particles, such as silica particles, in the processing tank 20. The substrates W, however, have been elevated above the processing tank 20 in the stage preceding step S10. This suppresses or prevents adhesion of particles, such as silica particles, that can be generated in the processing tank 20 to the substrates W. Air currents of the IPA vapors are formed by the nozzles 53 from above the processing tank 20 to the bottom of the processing tank 20. This suppresses or prevents contamination of the substrates W located above the processing tank 20 with the particles generated in the processing tank 20 and passing through the opening 20P.

When step S10 is further continued, the unreacted water repellent adhering to the inner wall and the like of the processing tank 20 and the particles, such as silica particles, generated by reaction of the water repellent with the IPA vapors are removed by the IPA vapors from the nozzles 52 and 53, and are drained to the drain line. As a result, the inside of the processing tank 20 has been cleaned when step S10 is completed.

It is desirable that the IPA vapors supplied from the nozzles 52 and 53 in step S10 be at a higher temperature than the water repellent supplied from the nozzles 54 in the water repellent processing performed in step S7. As a result, the water repellent can efficiently be removed from the surfaces of the substrates W.

The controller 80 then closes the valves 62, 63, and 64, and opens the valve 61. As a result, heated inert gas is supplied from the nozzles 51 to the substrates W located at the upper position. The surfaces of the substrates W are thereby eventually dried.

### Modifications

Although the IPA vapors and the nitrogen gas are discharged from separate supply nozzles in the present embodiment, the IPA vapors and the nitrogen gas may be discharged from the same nozzle.

In the above-mentioned embodiment, the IPA is used when moisture is removed from the surfaces of the substrates W (step S4), or when the water repellent is removed from the substrates (step S10). Any organic solvent, other than the IPA, that can be replaced with the rinse, such as water, and a solvent used in the water repellent can be used.

The present invention can effectively be used for processing of a substrate.

While the invention has been shown and described in detail, the foregoing description is in all aspects illustrative and not restrictive. It is therefore understood that numerous modifications and variations can be devised without departing from the scope of the invention.

What is claimed is:

1. A substrate processing method comprising the steps of:
dipping a substrate into a rinse stored in a processing tank to clean a surface of said substrate with the rinse;
supplying an organic solvent vapor into a chamber surrounding said processing tank to form an organic solvent vapor atmosphere inside the chamber including space above said processing tank;
elevating said substrate to the space above said processing tank to replace the rinse adhering to the surface of said substrate with an organic solvent;
draining the rinse stored in the processing tank;
moving said substrate into said processing tank;
supplying water repellent to the surface of said substrate having been moved into said processing tank to make the surface of said substrate water-repellent;
elevating said substrate above said processing tank, and supplying an organic solvent vapor to said substrate above said processing tank to remove unreacted water repellent remaining on the surface of said substrate; and
supplying inert gas to said substrate to dry said substrate.

2. The substrate processing method according to claim 1, wherein
said organic solvent is IPA.

3. The substrate processing method according to claim 1, wherein
the organic solvent vapor supplied to said substrate in removing the unreacted water repellent is at a higher temperature than the water repellent supplied to said substrate in making the surface of said substrate water-repellent.
